(19) United States
(12) Patent Application Publication
(10) Pub. No.: US 2016/0141923 A1
(43) Pub. Date: May 19, 2016

(54) Rotor for a reluctance motor, in particular a synchronous reluctance motor, method for producing such a rotor, and reluctance motor comprising such a rotor

(71) Applicant: Ziehl-Abegg SE, Künzelsau (DE)

(72) Inventor: Walter Frölich, Ingelfingen-Stachenhausen (DE)

(73) Assignee: Ziehl-Abegg SE, Künzelsau (DE)

(21) Appl. No.: 14/787,373

(22) PCT Filed: Apr. 29, 2014
(86) PCT No.: PCT/EP2014/001141

§ 371 Date: Feb. 1, 2016

(30) Foreign Application Priority Data
Apr. 30, 2013 (DE) 10 2013 007 988.8
Apr. 25, 2014 (DE) 10 2014 006 288.0

(51) Int. Cl. H02K 1/24; H02K 19/14; H02K 5/04; H02K 15/02

(52) U.S. Cl. CPC H02K 1/246; H02K 15/022; H02K 19/14; H02K 5/04

(57) ABSTRACT

The rotor comprises rotor segments consisting of a magnetically conductive material, which segments are distributed across the circumference of a rotor housing. Rotor housing portions of low magnetic conductivity are located between the rotor segments. The rotor segments are embedded in a main body in such a way that the outside or inside of the main body forms a closed housing. To produce the rotor a star-shaped blank is punched out of a metal sheet, the arms of said blank being bent out in relation to a central part connecting said arms, in order to form the rotor segments.

The invention relates to a rotor for a reluctance motor, in particular a synchronous reluctance motor, according to the preamble of Claim 1, a method for producing such a rotor according to the preamble of Claim 17 and a reluctance motor comprising such a rotor according to Claim 19.

With increasing performance capability of electronic motor controls, variable rotation speed drives are of interest for fields of application which for cost reasons have hitherto been operated predominantly with line frequency-dependent fixed rotation speeds. For example, fans for the cooling field are designed to the necessary peak load, but are predominantly operated in the partial-load range. The efficiencies which are able to be achieved here are less than in the design point, depending on the type of electric motors which are used for the fans.

In recent years, permanently energized synchronous machines (brushless electronically commutated motors) have proved to be successful in rotation speed-variable applications. They are equipped with integrated control electronics for ventilation drives of up to approximately 10 kW output. The efficiencies of such permanent magnetically energized motors in the lower and middle performance range lie distinctly above those of the AC squirrel cage motors and also have the potential to achieve the future efficiency class IE4 in smaller overall sizes.

A disadvantage, however, is that the necessary permanent magnet materials are only able to be used for limited temperature ranges. In addition, the cost situation is very uncertain, especially for high-performance materials, such a1s neodymium iron boron, and is tending upwards due to the worldwide high demand. Furthermore, it is disadvantageous that the installation processes, such as the bonding and the magnetizing of the magnets require particular care and therefore provide a not insignificant contribution to the production costs.

To an increasing extent, the energy requirement of drives is seen not only under best case conditions, but is also determined under real or respectively under mean load conditions. In particular in ventilation technology, the necessary drive performances are designed for peak load; the most frequent operating state, however, lies distinctly below this value. Depending on the design, the efficiency of permanent magnet-energized synchronous motors in the partial load range can be distinctly less. In a consideration of the so-called lifecycle costs, this can be disadvantageous.

Reluctance motors operate entirely without magnets, in which a differentiation is made between switched reluctance motors and synchronous reluctance motors. Switched reluctance motors have a high torque ripple inherent to the functional principle. It can be reduced by the synchronous reluctance motors to an extent which is comparable to permanent-energized motors.

As the prices for the materials of permanent magnets are constantly rising, in the output range of up to a few 10 kW, synchronous reluctance motors are being used increasingly as internal rotor motors. The fact that sensor-free rotor position detection systems have been improved and can be realized more simply has also contributed to this.

Basically, the reluctance motor operates with a conventional multiphase distributed winding or with a multiphase tooth coil winding. The multipolar magnetic field generated by the stator winding exerts magnetic attractive forces on a rotor which only has an even number of magnetic saliencies according to the number of poles of the stator. Thereby, the magnetic saliencies of the rotor are aligned in the direction of the rotating stator field, so that the rotor runs synchronously to the poles of the stator field. Through the reluctance (magnetic conductivity), forces are generated in the preferred directions, provided by the magnetic saliencies, by each pole pair, which bring about a synchronous course between the excitation field of the stator and the saliencies of the rotor.

Known reluctance motors have rotor segments of magnetically conductive material, which are held in a main body of the rotor housing of less well magnetically conductive material. The synchronous running is impaired by harmonics of the excitation flux or respectively by alternating torques due to load change, which lead to flux changes in the rotor segments. Thereby, the synchronism of such reluctance motors is impaired.

Primary object of the invention is to construct the generic rotor, the generic method and the generic reluctance motor so that the rotor can be produced and manufactured simply and cost-efficiently, and that a good synchronism of the reluctance motor is ensured by it.

This object is solved in the generic rotor according to the invention with the characterizing features of Claim 1, in the generic method according to the invention with the characterizing features of Claim 17, and in the generic reluctance motor according to the invention with the features of Claim 19.

In the rotor according to the invention, the rotor segments are embedded in a main body in such a way that it completely covers the rotor segments internally or externally. In this way, the main body forms a closed housing on the inside or on the outside of the rotor. The rotor with a closed circumferential housing on the inside can be used for an internal rotor motor, and with a closed circumferential housing on the outside can be used for an external rotor motor. The main body gives the rotor a high strength and stability.

The main body can consist of plastic. In this case, for the formation of the short-circuit winding, it is necessary to use a correspondingly conductive additional material.

In an advantageous embodiment, the main body can also consist of metallic material, in particular of aluminium. Then the rotor can be manufactured in a proven manner from aluminium die casting. In such a construction, the metallic material serves not only for the formation of the main body, but at the same time for the realization of the magnetic flux stabilization.

The rotor segments can consist of a one-piece metal sheet.

However, it is also possible to manufacture the rotor segments from layered sheet metal plates. They are placed on one another and connected with one another in a suitable manner, for example glued.

In an advantageous embodiment, the longitudinal centre plane of the rotor segment, viewed transversely to the axis of the rotor, forms an angle with the axial plane of the rotor. Such a construction contributes to the excellent synchronism of the reluctance motor which is equipped with the rotor.

The rotor segments are advantageously constructed here so that the longitudinal edges of the rotor segment run parallel to the longitudinal centre plane of the rotor segment, viewed transversely to the axis of the rotor.

In the rotor according to the invention, the rotor segments advantageously lie between two flux rings closing the magnetic circuit. The magnetic flux lines run from the flux rings in opposition to one another respectively into the rotor segments and via the rotor segment respectively adjacent in circumferential direction back to the flux ring. In this way, two magnetic flux circuits are associated with each rotor segment, of which one magnetic flux circuit runs via the one flux ring and the other magnetic flux circuit runs via the opposite flux ring. Through such a configuration, an excellent synchronism is produced of the reluctance motor which is equipped with the rotor.

In this guidance of the magnetic flux in axial direction, the flux coming from the stator is divided into two axial components. The separation line runs in circumferential direction in the centre of the rotor segments. The respective return path for these two flux components via the flux rings permits an optimum utilization of the flux-guiding iron parts of the rotor. Also, axial forces can thereby be balanced in a very simple manner.

When the flux guidance takes place in the rotor of the synchronous reluctance motor in circumferential direction, the flux coming radially from the stator (d-axis) divides itself into two circumferential components, which are directed in opposition to one another through two adjacent rotor segments.

A simple and cost-efficient manufacture of the rotor is produced when the flux rings are detachably connected with the rotor segments, advantageously with screws.

The screws are advantageously screwed into the narrow sides of the rotor segments, which lie with these narrow sides in a planar manner against the flux rings. Thereby, a good transition is produced of the magnetic flux lines from the rotor segments to the flux rings.

The flux rings are constructed so as to be and lie respectively in a radial plane of the rotor.

Advantageously, a cap adjoins the one flux ring, which cap is advantageously constructed in one piece with the flux ring. The rotor can be closed at one end by the cap.

In a preferred embodiment, the cap is provided on the inside with a cover which consists of electrically conducting material.

It is advantageous here if the cover is constructed in one piece with the main body.

A contribution is made to a simple composition of the rotor if a projection protrudes from the cap, in which projection the one end of a rotor shaft is fastened.

In a further embodiment according to the invention, the rotor segments are constructed in one piece with a rotor base. In this case, the rotor segments with the rotor base can be punched in a simple manner from a metal sheet. In the transition region from the rotor base to the rotor segments, at least one short-circuit winding is provided.

Here, the construction can be made such that all rotor segments have a shared short-circuit winding. In this case, it is constructed in a ring shape.

However, it is also possible that each rotor segment has its own short-circuit winding in the transition region.

In the method according to the invention, a metal sheet is used as starting material for the production of the rotor segments, from which metal sheet a star-shaped blank is punched. The arms of this blank are then bent out from the plane of the blank in relation to a central part connecting said arms, in order to form the rotor segments. In this way, the rotor segments can be produced in a simple and cost-efficient manner by a punching process. The rotor segments, constructed in one piece with the rotor base, are then held by the material of the main body. For this, a plastic overmoulding of the rotor segments and of the rotor base or else an aluminium die casting method can be used.

When the rotor segments are to consist of layered sheet metal plates, a plurality of star-shaped blanks are punched from one metal sheet, which are then placed on one another and connected with one another in a suitable manner. The arms of the thus formed layered blank are then bent out from the plane of this blank in order to form the rotor segments.

It is advantageous here if the outline shapes of the individual blanks differ slightly in size, so that during the bending process the rotor segments have a desired uniform outline shape.

The reluctance motor according to the invention with the rotor is distinguished by a very good synchronism. With the reluctance motor, in particular when it is constructed as a synchronous reluctance external rotor motor, motor efficiencies can be achieved in a comparable manner to those of permanent-magnet-energized synchronous motors. The reluctance motor does not require any permanent magnets. The stator corresponds to that of a conventional asynchronous motor. The robustness and temperature sensitivity is comparable to those of an asynchronous motor.

The subject of the application is produced not only from the subject of the individual claims, but also through all information and features disclosed in the drawings and in the description. They are claimed as essential to the invention, even if they are not the subject of the claims, in so far as they are novel with respect to the prior art individually or in combination.

Further features of the invention will emerge from the further claims, from the description and from the drawings.

The invention is explained in further detail below with the aid of some embodiments, illustrated in the drawings. There are shown:

FIG. 1 in perspective illustration, a rotor according to the invention, which is used for an external rotor motor,

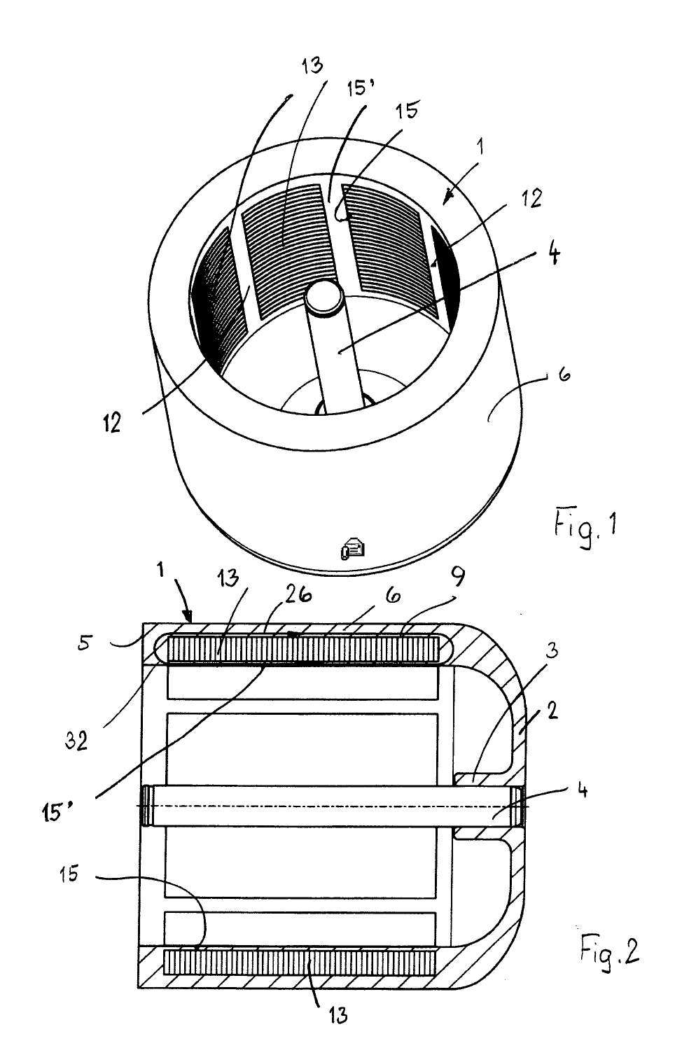

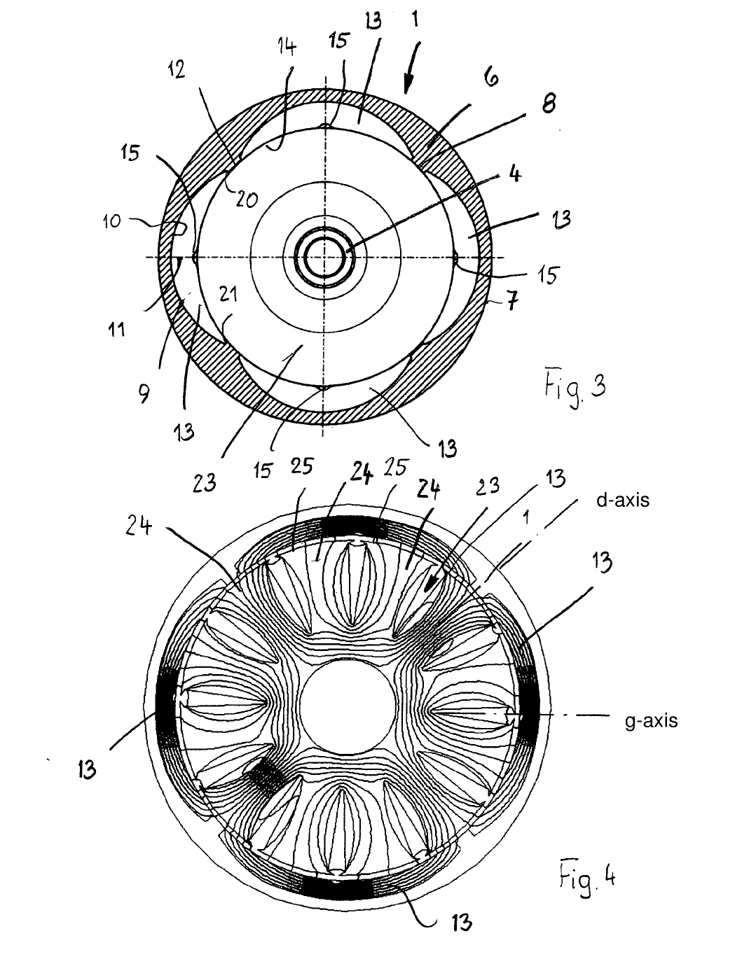

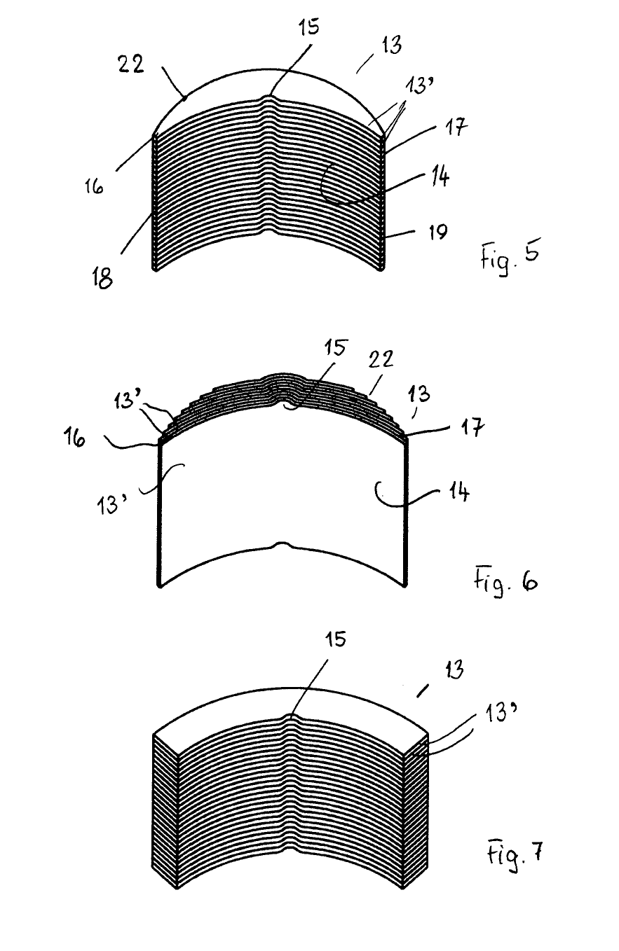

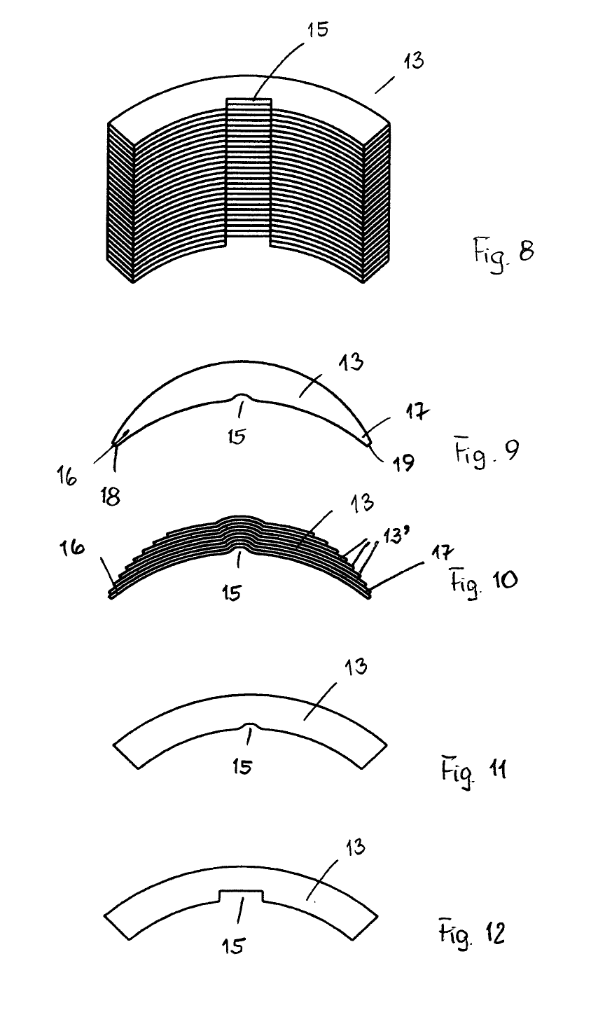

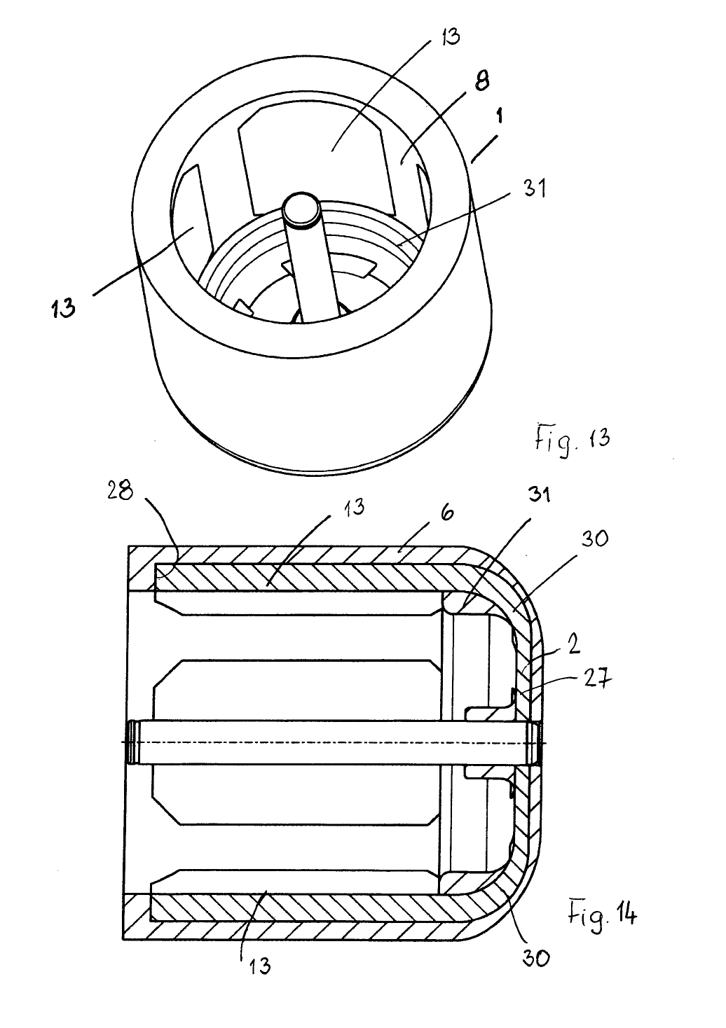

FIG. 2 an axial section through the rotor according to FIG. 1,

FIG. 3 radial section through the rotor according to FIG. 1,

FIG. 4 the magnetic flux within the rotor according to FIG. 1,

FIG. 5 to FIG. 12 various embodiments of segments of the rotor according to the invention, in perspective illustration and in top view,

FIG. 13 in perspective illustration, a second embodiment of a rotor according to the invention, for an external rotor motor,

FIG. 14 an axial section through the rotor according to FIG. 13,

FIG. 15 in perspective illustration, a third embodiment of a rotor according to the invention, for an external rotor motor,

FIG. 16 an axial section through the rotor according to FIG. 15,

FIG. 17 in perspective illustration, shaped rotor sheets of the rotor according to FIG. 15,

FIG. 18 a further embodiment of shaped rotor sheets for the rotor according to FIG. 15,

FIG. 19 the magnetic flux within a reluctance internal rotor motor,

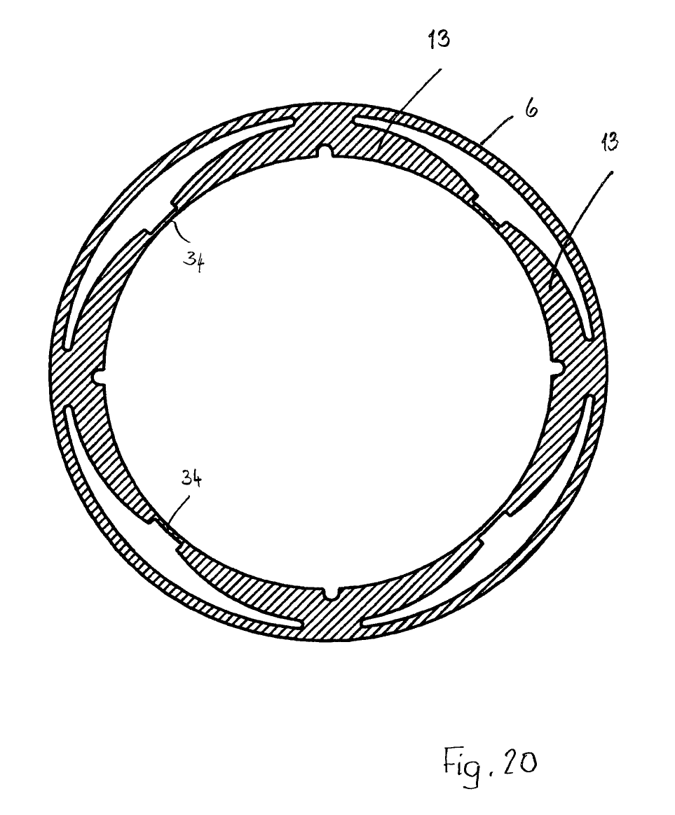

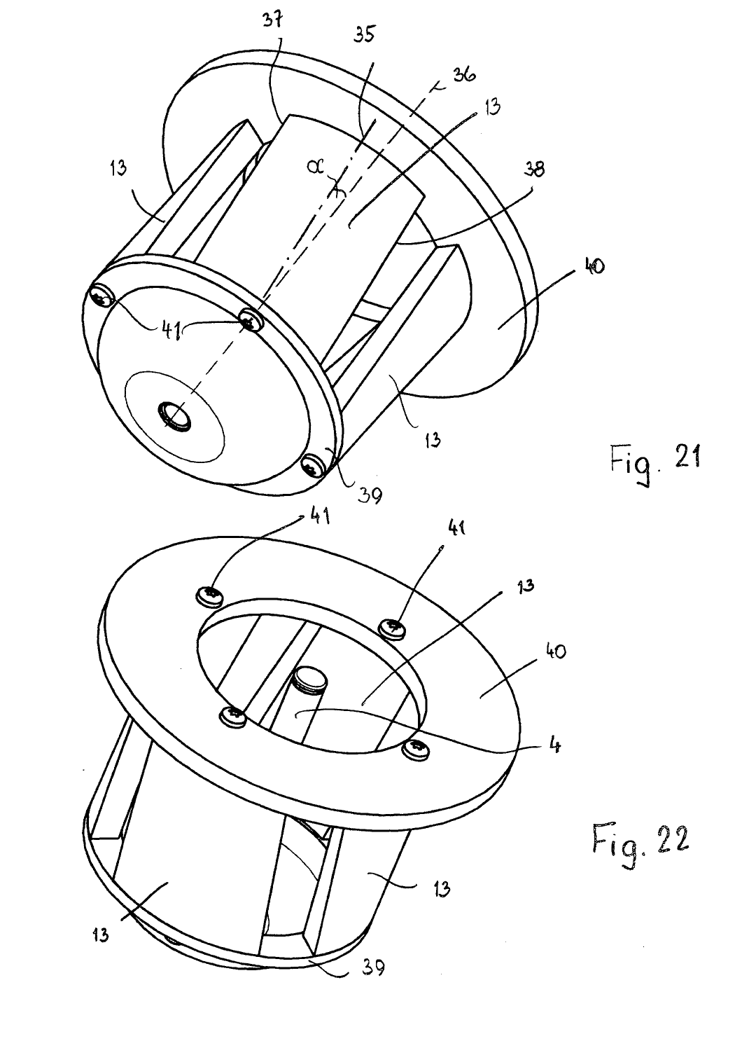

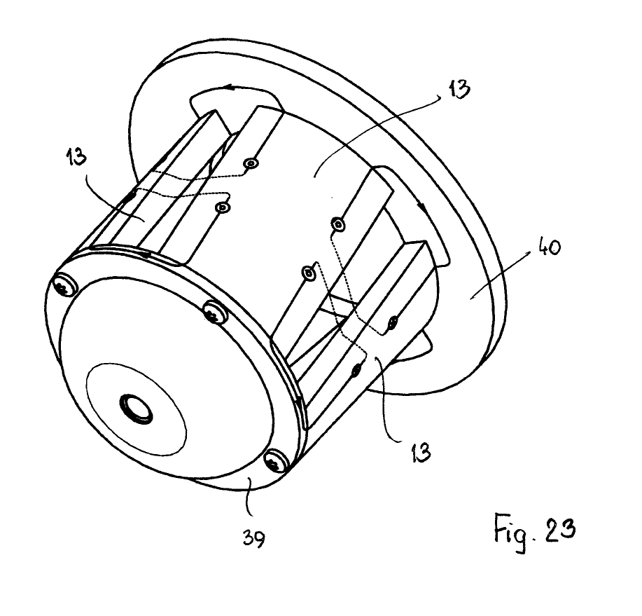

FIG. 20 a further embodiment of a rotor according to the invention in a radial section for an external rotor motor,

FIG. 21 in perspective illustration, a further embodiment of a rotor according to the invention for an external rotor motor,

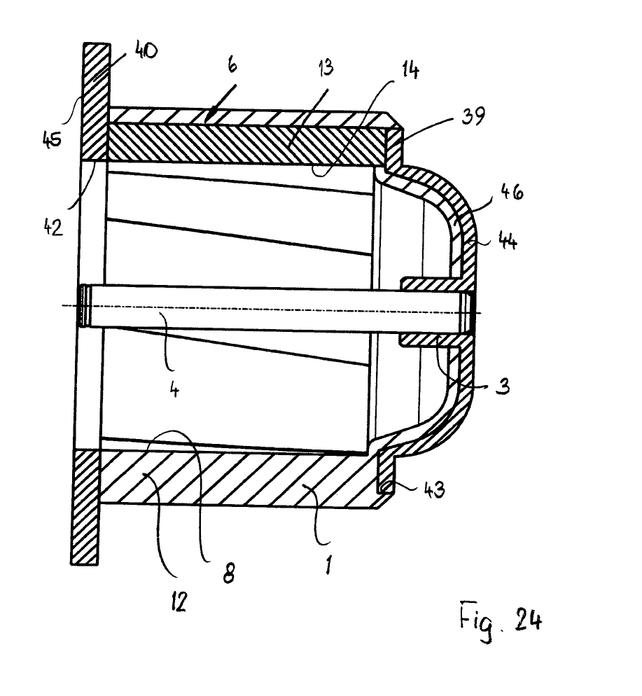

FIG. 22 the rotor according to FIG. 21 in another perspective illustration,

FIG. 23 in diagrammatic illustration, the course of the magnetic flux in the rotor according to FIGS. 21 and 22,

FIG. 24 an axial section through the rotor according to FIG. 21 to 23,

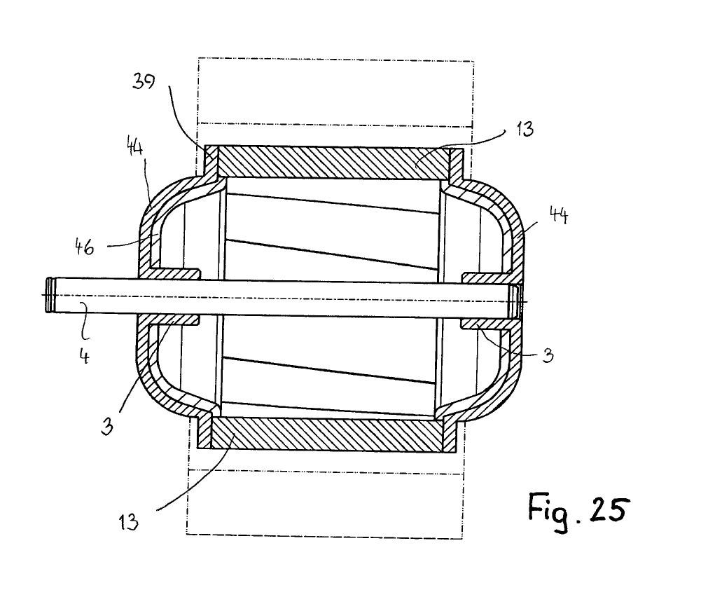

FIG. 25 an axial section through a further embodiment of a rotor according to the invention for an internal rotor motor.

The rotors described below are used for reluctance motors, in particular for synchronous reluctance external rotor motors. The rotors have regions with high and with low magnetic conductivity arranged distributed over their circumference. The structure of the rotors is configured such that zones of good or respectively poor magnetic conductivity are present alternately in circumferential direction.

FIG. 1 shows a rotor for an external rotor reluctance motor with a cylindrical housing 1, which continues at one end into a base 2. At the other end, the housing 1 is open. The base 2 is provided centrally with a bush-shaped projection 3, in which the one end of a rotor shaft 4 is fastened. Its other end lies at the height of the face side 5 of the housing 1.

The housing 1 has a main body 6, which consists of a material with a low magnetic conductivity, for example of plastic or aluminium. The outside of the main body 6 forms the outer closed housing surface 7 (FIG. 3). In the inside 8 of the main body 6, four depressions 9 are situated, which are constructed identically to one another and are arranged in angular distances of for example 90° to one another with a four-pole motor variant. The depressions 9 have respectively a base 10 in the shape of a partial circle in radial section, which is constructed symmetrically to the respective axial plane 11 of the rotor. Between adjacent depressions 9, axially-running webs 12 remain, the face side of which lies in the inside 8 of the housing 1.

It is pointed out that in the illustration according to FIGS. 1 and 3, on the inside of the main body 6 only, for example, four depressions 9 are provided. The number of the depressions depends on the pole number and therefore on the case of use of the rotor and is also determined according to the relationship 360°/pole number.

Rotor segments 13 are situated in the depressions 9, which rotor segments consist of material having good magnetic conductivity, in particular of iron, steel and suchlike. The rotor segments 13 are configured so that they lie in a planar manner on the base 10 of the depressions 9 and their insides 14, facing the rotor shaft 4, lie in the inside 8 of the housing 1.

In the production of the rotor, the main body 6 is produced by a plastic overmoulding or by an aluminium die casting method. The rotor segments 13 are thereby embedded securely into the main body 6.

FIG. 5 to 12 show various embodiments of the rotor segments 13. The rotor segment 13 according to FIGS. 5 and 9 corresponds to the rotor segment according to FIG. 3. It consists of identical sheet metal parts 13′ lying on one another, which are connected with one another in a suitable manner. The sheet metal parts 13′ are stamped for example from one metal sheet, which is unwound from a coil. The sheet metal parts 13′ lie in radial planes of the rotor. On their inside 14, the sheet metal parts 13′ are provided respectively with a depression 15 in the shape of a partial circle. It lies in all sheet metal parts 13′ in half the width of the respective sheet metal part. The sheet metal parts 13′, lying on one another, thereby form an axially-running groove 15, which is arranged symmetrically to the associated axial plane 11 of the rotor (FIG. 3). These grooves 15 are filled with an electrically conductive material (FIG. 1). When the main body 6 consists, for example, of aluminium, the material Situated in the grooves 15 is then likewise aluminium. As the grooves 15 of the rotor segments 13 are open at both ends, the material situated in the depressions 15, forming webs 15′, is formed in one piece with the remaining part of the main body 6. The grooves 15 can also be provided running obliquely, in order to keep the groove detent torques small.

When the main body 6 consists of non-magnetically conductive material, e.g. of plastic, electrically conductive material is then introduced into the grooves 15 and short-circuit windings are provided on the upper side and underside of the rotor segments 13, to which short-circuit windings the conductive material in the grooves is connected and which are embedded into the main body 6.

In the embodiment according to FIGS. 6 and 10, the rotor segment 13 is formed from individual sheet metal parts 13′ lying one behind the other in radial direction, which lie in a planar manner against one another and are connected securely with one another in a suitable manner, for example by gluing. The sheet metal parts 13′ decrease in their width, measured in circumferential direction, in accordance with the shape of the depressions 9 of the main body 6. The sheet metal parts 13′ are likewise provided in half width with a depression 15, which as in the previous embodiment lies symmetrically to the transverse centre plane of the rotor segment 13. The depressions 15 likewise have an outline in the shape of a partial circle and are filled with conductive material.

The rotor segments 13 of the embodiments according to FIGS. 5 and 6 or respectively 9 and 10 taper continuously in circumferential direction, proceeding from the transverse centre plane. The rotor segments therefore have the smallest width at their two lateral edges 16, 17. The lateral edges 16, 17 have respectively a flat face side 18, 19, by which the rotor segments 13 lie against corresponding flat lateral faces 20, 21 (FIG. 3) of the depressions 9. These lateral faces 20, 21 form the lateral faces of the webs 12 between adjacent depressions 9.

The sheet metal parts 13′ of the example embodiment according to FIGS. 5 and 9 lie in radial planes of the rotor. The rotor segment 13 has a continuously curved outside 22 and the continuously curved inside 14. In the embodiment according to FIGS. 6 and 10, on the other hand, only the inside 14 of the rotor segment 13 is continuously curved, whereas the outside 22, as a result of the sheet metal parts 13′ lying radially one behind the other, is configured in a stepped shape. As, however, the rotor segment 13 is embedded into the main body 6, this configuration of the outside 22 of the rotor segment 13 is not disadvantageous.

The rotor segment 13 according to FIGS. 7 and 11 consists, in turn, of identical sheet metal parts 13′ lying on one another in radial planes of the rotor. In contrast to the two previous example embodiments, the curved sheet metal parts 13′ have a constant width over their circumferential length. Accordingly, the depressions 9 are also constructed in the main body 6 so that they have a constant depth in circumferential direction. The sheet metal parts 13′ have, again, in half length the depressions 15 which are constructed in the shape of a partial circle in radial section and form an axially-running groove in the rotor segment 13.

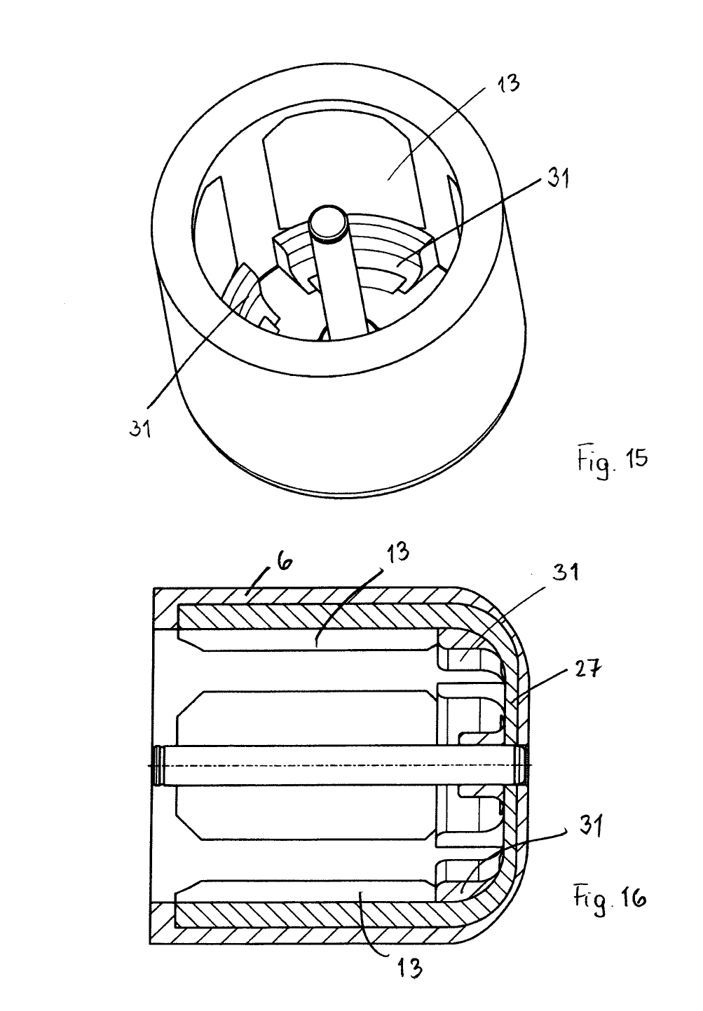

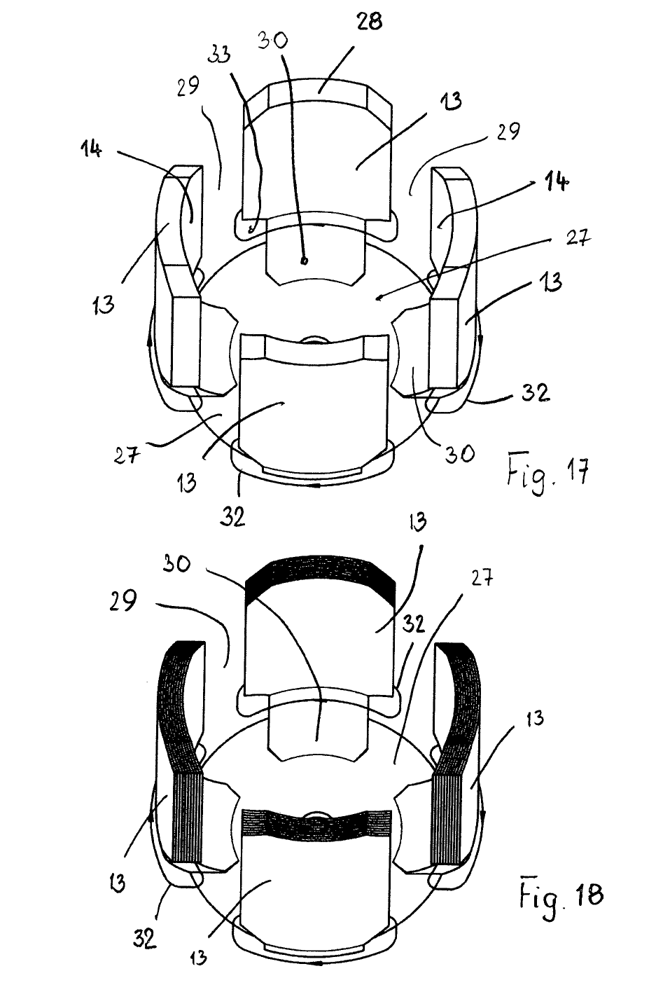

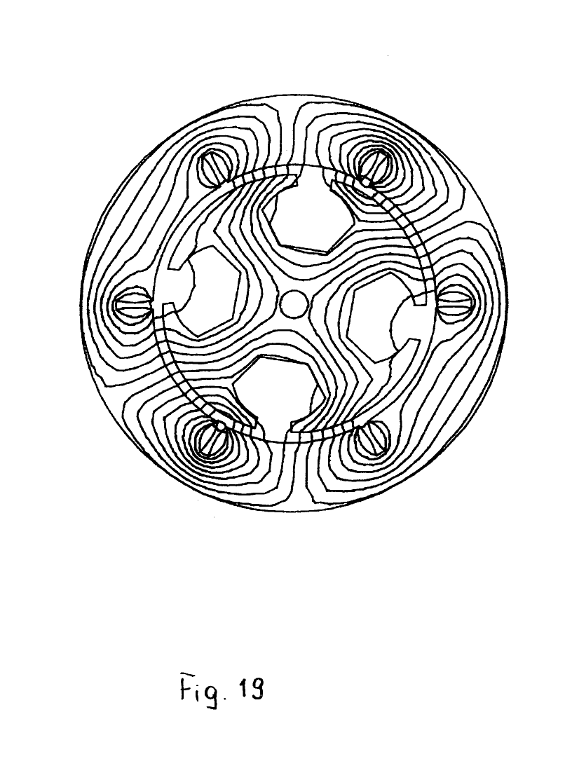

The rotor segment 13 according to FIGS. 8 and 12 differs from the rotor segment according to FIGS. 7 and 11 only by the shape of the central depressions 15. It is configured in a rectangular shape in radial section and lies symmetrically to the transverse centre plane of the rotor segment 13. As in the previous embodiments, the depressions 15 form an axially-running groove in the rotor segment 13.

A motor equipped with the rotor according to FIG. 1 to 4 corresponds to a permanent-magnet-energized external rotor motor. Instead of the magnet segments present in the known external rotor motors, the described rotor segments 13 are situated on the inside of the rotor housing 1, said rotor segments consisting of individual sheet metal parts 13′ which consist of magnetically conductive material. The number of the rotor segments 13 corresponds to the pole number of the respective motor. The rotor segments, except for their inside, are completely surrounded by the material of the main body 6. This material has only a low magnetic conductivity and is, for example, plastic or aluminium. Through the described structure, zones of alternately good and of poor magnetic conductivity are produced in circumferential direction of the rotor housing 1. The stator 23, illustrated only diagrammatically (FIG. 4), which is overlapped in the form of a cap by the cup-shaped rotor, can be constructed, as regards structure, like a stator of a known external rotor motor, such as a synchronous or asynchronous motor with a tooth coil winding or with a distributed multi-strand winding.

The multipolar magnetic rotary field, generated by the stator 23 via an electronic control preferably without a position sensor, brings about a magnetic flux through the rotor segments 13, which endeavours to increase the magnetic flux. The magnetic rotary field of the rotor is illustrated by way of example. The magnetic lines are illustrated in FIG. 4 for the motor which is provided with the rotor. The stator has radially-running teeth 24, which are arranged distributed uniformly in a known manner in circumferential direction of the stator. Each tooth 24 has a face side 25 lying opposite the inside 8 of the rotor housing 1, which face side runs parallel to the inside 8 of the rotor housing 1. It can be seen from FIG. 4 that the radially-running magnetic lines in the respective stator tooth 24 arrive at an end lying in circumferential direction into the rotor segments 13 and are guided there in circumferential direction to the other end of the rotor segment 13. From here, the magnetic lines, running over the axial height of the rotor elements 13, run over the corresponding further stator tooth 24 radially inwards back to the stator. In this way, a closed magnetic circuit is produced, which runs over the corresponding stator teeth 24 and the rotor segments 13. The shape of the rotor segments 13 permits as great as possible a difference of the reluctance in the two d- and q-axes fixed to the rotor (FIG. 4).

As the concern is with a rotary field, a torque is exerted onto the rotor segments 13, so that the rotor synchronously follows the rotary field running ahead. The rotor position detection of the control electronics of the motor makes provision that up to a maximum torque an efficiency-optimum field control takes place with a corresponding drag angle.

The teeth 24 of the stator 23 are provided in a known manner with the corresponding windings. On supplying with a rotary current, they generate a rotary field circulating in the air gap between the stator 23 and the rotor. The stator teeth 24 with the energized windings respectively attract the nearest rotor segments 13 of the rotor and are less energized sinusoidally in a known manner when the rotor segments 13 of the rotor come nearer to the stator teeth 24 which are attracting them. At the same time, the next phase to the other stator teeth 24 is energized increasingly more intensively, which in turn attract other rotor segments 13. With the rotor position detection, it is ensured that the optimum phase position of the stator currents is controlled. The associated path of the current is preferably controlled sinusoidally, so that torque-influencing harmonics are avoided to the greatest possible extent.

As can be seen from FIG. 2, a conductor loop 26 of the described short-circuit winding runs in axial direction of the rotor around the rotor segments 13 perpendicularly to the magnetic lines.

The motor with the rotor according to FIG. 1 to 4 forms, as can be seen from FIG. 4, an external rotor motor with rotor Segments 13 separated from one another. The motor is advantageously used for fans. In this case, fan blades provided on the outside 7 of the rotor.

In the embodiments according to FIG. 13 to 18, the rotor segments 13 are connected with one another via the base 2. The rotor has the rotor segments 13 (FIG. 17), which are constructed in one piece with a base section 27. Star-shaped blanks are punched from a metal sheet. The arms of the blank are bent out from the plane of the blank in order to form the rotor segments 13. The central part of the blank forms the base section 27. The construction according to FIG. 17 is produced by the described stamping and bending method.

The possibility also exists of laying several stamped metal sheets on one another and connecting them to one another and then bending the rotor segments 13 out in relation to the base section 27, as can be seen from FIG. 18.

With the two embodiments according to FIGS. 17 and 18, a very simple and cost-efficient manufacture results.

The rotor segments 13 and the base section 27 are embedded into the main body 6, which consists of a material with low magnetic conductivity, such as plastic or aluminium. As FIG. 14 shows, the main body 6 completely surrounds the rotor segments 13 on the outside and also covers the free ends 28 of the rotor segments 13. The base section 27 is likewise completely surrounded by the main body 6 on the underside. The axial intermediate spaces 29 (FIGS. 17 and 18) between adjacent rotor segments 13 are completely filled by the material of the main body 6. In this way, a rotor is produced with a closed housing 1, which has an approximately constant thickness over its circumference.

The rotor segments 13 are respectively constructed identically and have, for instance, a rectangular shape. They are constructed in a curved manner over their height in circumferential direction, so that the inside 14 of the rotor segments lies in the inside 8 of the housing 1. The free edge 28 of the rotor segments 13 is chamfered at its two ends lying in circumferential direction. The rotor segments 13 are connected with the base section 27 via a narrow intermediate piece 30. The intermediate pieces are narrower than the rotor segments 13 and lie symmetrically to them. Thereby, a secure connection is ensured between the main body 6 and the rotor segments 13.

On the base section 27 a short-circuit winding 31 is applied, which extends up to the lower edge of the rotor segments 13 (FIG. 14). The short-circuit winding 31 extends over 360°.

In the embodiment according to FIGS. 15 and 16, instead of the circumferential short-circuit winding 31, each rotor segment 13 is provided with its own short circuit part 31. In other respects, the rotor according to FIGS. 15 and 16 is constructed identically to the rotor according to FIGS. 13 and 14.

In the embodiments according to FIG. 13 to 16, the magnetic flux guidance in the rotor elements 13, in contrast to the embodiment according to FIG. 1 to 4, takes place in axial direction. The magnetic flux coming from the stator flows firstly radially into the corresponding rotor segment 13, in which the magnetic flux runs in axial direction to the base section 27. Via the latter, the magnetic lines pass over to the adjacent rotor segment 13.

As in the embodiments according to FIG. 15 to 18 a short-circuit winding 31 is associated with each rotor segment 13, which short-circuit winding is situated in the foot region of the rotor segments, the conductor loop 32 is produced, drawn diagrammatically in FIGS. 17 and 18, which surrounds the foot region of the rotor segments 13. The conductor loops 32 indicate the respective short-circuit winding 31. Through the induction current in the closed conductor loops 32, a flux-stabilising effect is produced, whereby harmonics occurring through the magnetic excitation are considerably reduced. These harmonics lead to changing magnetic fluxes, as is the case in tooth coil windings to an increased extent. Through the described constriction 33 between the rotor segment 13 and the intermediate piece 30, the respective short circuit part 31 can be provided simply and reliably on the rotor. In the case where the main body 6 consists for example of aluminium, the short circuit parts 31 consist of the same material. If, however, plastic is used for the main body 6, a separate part of electrically conductive material is then introduced in the foot region of the rotor segments 13 for the short circuit part 31.

The flux changes in the rotor segments, brought about by the harmonics of the excitation flux or respectively by alternating torques due to load changes, lead to the formation of a secondary current in the short-circuit winding, which counteracts these changes and attempts to maintain the synchronous running of the rotor with the stator rotary field. Thereby, an excellent synchronism of the reluctance motor is the result.

As can be seen from FIGS. 17 and 18, the short circuit parts 31 of adjacent rotor segments 13 have a distance from one another in circumferential direction.

In the foot region of the rotor segments 13, a constriction 33 does not have to be provided. In this case, the intermediate piece 30 has the same circumferential width as the rotor segment 13. In the embodiment according to FIGS. 13 and 14, instead of the individual short circuit parts, the circumferential short-circuit winding 31 is used, which has the same effects as the individual short circuit parts 31 associated with the rotor elements 13.

The rotors according to FIG. 13 to 18 are constructed so as to be cap-shaped as in the first embodiment, and surround the stator 23 (FIG. 4).

Whereas in the embodiments according to FIG. 13 to 18 the conductor loops 32 are provided at the foot end of the rotor segments 13 and surround the foot regions, the conductor loops 26 in the rotor according to FIG. 1 to 4 run in vertical direction of the rotor segments 13 through the webs 15′, which are provided in the described manner in half the circumferential width of the rotor segments 13. When the main body 6 in the rotor according to FIG. 1 to 4 consists of plastic, the web 15′, lying in the depressions 15, consists of electrically conductive material and adjoins at the upper and lower end onto the short circuit rings which are embedded into the material of the main body 6. When, on the other hand, the main body 6 consists of electrically conductive material, for example of aluminium, then no other material is necessary for the webs 15′ in the depressions 15 of the rotor segments 13.

In all the embodiments, through additional webs of magnetically conductive material and additional short circuit rings, in a comparable manner to an asynchronous motor, synchronous reluctance motors can be obtained, which can be operated in a self-starting manner at a fixed supply frequency.

In the described embodiments, the rotors are provided for external rotor reluctance motors. The respective short-circuit winding 31 lies in a plane normal to the magnetic flux direction. In the case of the rotor according to FIG. 1 to 4, the short-circuit windings 31 lie in axial planes, whereas in the rotors according to FIG. 13 to 18 they run in radial planes.

If aluminium is used for the main body 6 which gives the rotor the necessary mechanical strength and stability, then this material also serves at the same time for the realization of the flux stabilisation. With the use of plastic for the main body 6, in addition electrically conductive materials must be used to achieve the short circuit. The rotor segments 13 and the base section 27 are embedded for example by plastic overmoulding or by aluminium die casting.

FIG. 19 shows the magnetic flux within a reluctance internal rotor motor. The magnetic lines run from the teeth Of the rotor radially into the stator, within which they run in circumferential direction to the next tooth of the rotor, into which they enter again radially. The magnetic lines run within the rotor from one tooth to the adjacent tooth.

It can be seen that in this reluctance internal rotor synchronous motor substantially a radial flux direction occurs. Thereby, it is possible to influence the saliency of the LD/LQ ratio necessary for the torque formation through the shape of the groove 15, in particular through the groove depth. As in the described external rotor variants, through electrical short circuit rings around the groove webs, a suppression of flux changes and therefore a reduction of the harmonics and alternating torques is achieved.

FIG. 20 shows the possibility of assembling the rotor segments to a rotor packet in the described manner and of embedding the rotor segments 13 into the main 6, for example by a plastic overmoulding or by an aluminium die casting method. The rotor which is thus produced is subsequently processed by a turning process, so that the webs 34 remaining between the rotor segments 13 lying one behind the other in circumferential direction are removed. In this way, the magnetic conductivity between the rotor segments 13 is reduced. The relatively thin webs 34 between the rotor segments 13 are provided in order to facilitate the positioning of the rotor segments 13 in the aluminium die casting process or in the plastic overmoulding. The rotor segments 13 are aligned precisely with respect to one another via the webs 34. After the embedding of the rotor segments 13 into the plastic or respectively into the aluminium, the webs 34 can be removed in simple manner by a turning process.

Preferably, a winding system assembled by a three-phase system is used as tooth coil winding of the stator 23. However, a distributed winding system can also be used in order to generate the magnetic rotary field in the operation of the motor.

The rotor segments 13 can be produced in the described manner either as complete sheet metal shaped parts, as illustrated by way of example in FIG. 17, or by layered electrical sheets.

The rotor according to FIG. 21 to 24 is provided for an external rotor reluctance motor and is constructed in a similar manner to the rotor according to FIGS. 15 and 16. The rotor has the main body 6 (FIG. 24), which is provided on the inside with the depressions, in which the rotor segments 13 lie. The main body 6 is produced by casting method and consists, in the example embodiment, of aluminium. The rotor segments 13 are arranged distributed uniformly over the circumference of the rotor and are embedded into the main body 6 so that their insides 14, facing the rotor shaft 4, lie in the inside 8 of the housing 1 of the main body 6.

The rotor segments are arranged in the rotor so that their longitudinal centre plane 35 (FIG. 21) runs at an acute angle α to the longitudinal centre plane 36 of the rotor, viewed in lateral view or respectively perpendicularly to the axis of the rotor. The longitudinal edges 37, 38 Of the rotor segments 13 run parallel to one another and parallel to the longitudinal centre plane 35. This skewing of the rotor segments 13 serves to reduce the torque ripple brought about by the grooving of the stator.

The rotor segments 13 connect two flux rings 39, 40 with one another, which are advantageously connected with the rotor segments 13 via screws 41. The flux ring 40 has a greater radial width than the opposite flux ring 39. The inner edge 42 of the flux ring 40 lies in the cylinder surface containing the insides 14 of the rotor elements 13 and the inside 8 of the main body 6. The flux ring 40 projects radially over the main body 6 and serves, at the same time, as a fastening flange for attachment parts, such as fan wheels.

The opposite flux ring 39 is covered by the main body 6 on the outer edge 43. on the inside, the flux ring 39 continues into a hood-shaped cap 44, which runs in an outwardly curved manner and has centrally the bush-shaped projection 3. It receives the one end of the rotor shaft 4, the other end of which lies approximately at the height of the outside 45 of the flux ring 40 facing away from the flux ring 39. The projection 3 is advantageously constructed in one piece with the cap 44. On the inside, the cap 44 is covered by a covering 46, which is formed in one piece with the main body 6 (FIG. 24). The covering 46 extends up to the projection 3.

FIG. 21 to 23 show the rotor without the main body 6, which consists of a material with low magnetic conductivity. Advantageously, the main body 6 consists of plastic in this embodiment.

The rotor segments 13, except for the inside 14, are completely surrounded by the material of the main body 6. As in the previous example embodiments, the webs 12 of the main body 6, which extend over the axial height of the rotor segments 13, are situated between the adjacent rotor segments 13.

FIG. 23 shows diagrammatically the course of the magnetic flux lines in the rotor according to FIG. 21 to 24. The magnetic flux lines run from the radially-running teeth of the stator (which is not illustrated) into the respective rotor segment 13. As FIG. 23 shows, a portion of the magnetic flux lines runs in longitudinal direction of the rotor segment 13 to the flux ring 39, and the other portion in longitudinal direction of the rotor segment in the direction of the flux ring 40. Within the two flux rings 39, 40, the flux lines run in circumferential direction and enter into the adjacent rotor segment 13. Here, the flux lines run inwards in longitudinal direction of the rotor segment and arrive over half the length of the rotor segment 13 radially into the teeth of the stator surrounded by the rotor. The magnetic flux lines run in this case again in circumferential direction of the rotor and arrive back to the preceding rotor segment 13. Between adjacent rotor segments, two circuits are formed in this way, in which the flux lines in a rotor segment 13 run to the flux rings 39, 40, via which the flux lines arrive at the adjacent rotor segment 13, in which the flux lines run directed inwards, opposed to one another.

The flux direction between the adjacent circuits in circumferential direction runs in opposition to one another. As the flow arrows in FIG. 23 show, the flux lines run at the right-hand longitudinal edge of the one rotor segment 13 in FIG. 23 within the flux rings 39, 40 in clockwise direction, whereas the flux lines at the left-hand longitudinal edge of this rotor segment run within the flux rings 39, 40 in anti-clockwise direction to the adjacent rotor segment 13.

In the described manner, a total of four circuits of the magnetic flux lines are associated with each rotor segment 13, wherein within each rotor segment 13 the magnetic flux lines run from the flux rings 39, 40 approximately over the half axial length of the rotor segments 13.

The magnetic flux coming from the stator is divided in the described manner into the two axial components. The separation line runs in circumferential direction of the rotor in the centre of the rotor segments 13.

The rotor segments 13 of the rotor according to FIG. 21 to 24 can also consist of layered plates, as has been described by way of example with the aid of FIG. 5 to 8.

The embodiment illustrated in FIG. 21 to 24 with axial rotor flux guidance constitutes a mechanically favourable. form the rotor structure for a synchronous reluctance motor both as an external rotor motor and also as an internal rotor motor. The magnetic return path takes place respectively via the attachment parts 39; 40, 44, which improve the mechanical structure of the rotor.

It becomes evident from FIG. 25 that the described operating principle is also able to be used in the same manner in an internal rotor synchronous reluctance motor. In such an embodiment, instead of the flux ring 40 according to FIG. 24, the flux ring 39 is provided with the hood-shaped cap 44, which runs in an outwardly curved manner opposed to the opposite cap 44 and has the bush-shaped projection 3 on the inside. It is likewise. advantageously constructed in one piece with the cap 44. On the inside, the cap 44 is likewise covered by the covering 46, which is formed in one piece with the main body.

The rotor segments 13 lie freely on the outside. The rotor shaft 4 is fastened by its one end in the right-hand projection 3 in FIG. 25 and projects through the opposite projection 3 beyond the cap 44. The rotor is surrounded by the stator, which is illustrated only diagrammatically, indicated by dot-and-dash lines.

What is claimed is:

1. A rotor for a reluctance motor, in particular a synchronous reluctance motor, with rotor segments (13) consisting of magnetically conductive material, which are arranged distributed across the circumference of a rotor housing (8) and between which segments regions (12) of the rotor housing (6) of low magnetic conductivity lie,
characterized in that the rotor segments (13) are embedded into a main body (6) in such a way that the outside or inside of the main body (6) forms a closed housing.

2. The rotor according to claim 1,
characterized in that the main body (6) consists of plastic or of metallic material, in particular aluminium.

3. The rotor according to claim 1,
characterized in that the rotor segments (13) consist of one-piece sheet metal.

4. The rotor according to claim 1,
characterized in that the rotor segments (13) consist of layered sheet metal plates.

5. The rotor according to claim 1,
characterized in that the longitudinal centre plane (35) of the rotor segments (13), viewed transversely to the axis of the rotor, forms an angle (α) with the axial plane (36) of the rotor.

6. The rotor according to claim 5,
characterized in that the longitudinal edges (37, 38) Of the rotor segment (13) run parallel to the longitudinal centre plane (35) of the rotor segment (13), viewed transversely to the axis of the rotor.

7. The rotor according to claim 1,
characterized in that the rotor segments (13) lie between two flux rings (39, 40) such that the magnetic flux lines run from the flux rings (39, 40) opposed to one another respectively into the rotor segments (13) and via the respectively adjacent rotor segment (13) in circumferential direction back to the flux ring (39, 40).

8. The rotor according to claim 7,
characterized in that the flux rings (39, 40) are detachably connected with the rotor segments (13), advantageously with screws (41).

9. The rotor according to claim 8,
characterized in that the screws (41) are screwed into the narrow sides of the rotor segments (13), which lie with their narrow sides in a planar manner against the flux rings (39, 40).

10. The rotor according to claim 1,
characterized in that a cap (44) adjoins onto the one flux ring (40), which cap is advantageously constructed in one piece with the flux ring (40).

11. The rotor according to claim 10,
characterized in that the cap (44) is provided on the inside with a cover (46) which consists of electrically conductive material.

12. The rotor according to claim 11,
characterized in that the cover (46) is constructed in one piece with the main body (6).

13. The rotor according to claim 1,
characterized in that a projection (3) projects from the cap (44), in which projection the one end of a rotor shaft (4) is mounted.

14. The rotor, in particular according to claim 1,
characterized in that the rotor segments (13) are constructed in one piece with a rotor base (27), and that in the transition region from the rotor base (27) to the rotor segments (13) at least one short-circuit winding (31) is provided.

15. The rotor according to claim 14,
characterized in that all rotor segments (13) have a shared short-circuit winding (31).

16. The rotor according to claim 14,
characterized in that each rotor segment (13) has a short-circuit winding (31).

17. A method for the production of a rotor for a reluctance motor, in particular for a synchronous reluctance motor, in particular according to claim 1,
characterized in that a star-shaped blank is punched from a metal sheet, the arms of which blank are bent out in relation to a central part connecting said arms, in order to form the rotor segments (13).

18. The method according to claim 17,
characterized in that for the formation of layered rotor segments (13), several star-shaped blanks are punched, which are laid on one another and connected to one another, and that the arms are subsequently bent out.

19. A reluctance motor, in particular a synchronous reluctance motor, with a rotor according to claim 1.
